(19) United States
(12) Patent Application Publication
(10) Pub. No.: US 2008/0218000 A1
(43) Pub. Date: Sep. 11, 2008

(54) Power-Off System and Method

(75) Inventors: Yoichi Ohshiro, Tokyo (JP); Kouji Ohmoto, Tokyo (JP); Takashi Ogawa, Tokyo (JP); Hikaru Yamada, Tokyo (JP); Yasunori Hamai, Hiroshima (JP)

Correspondence Address: RADER FISHMAN & GRAUER PLLC, LION BUILDING, 1233 20TH STREET N.W., SUITE 501, WASHINGTON, DC, 20036, US

(73) Assignee: The Tokyo Electric Power Company, Incorporated, Tokyo (JP)

(21) Appl. No.: 10/592,670

(22) PCT Filed: Jun. 22, 2006
(86) PCT No.: PCT/JP06/12543

§ 371 Date: Aug. 13, 2007

(30) Foreign Application Priority Data
Dec. 20, 2004 (JP) 2005-366609

(51) Int. Cl. H01H 83/00

(52) U.S. Cl. 307/116

(57) ABSTRACT

There is provided a power-off system including a connector (10) connected at one end thereof to a system power line (A) and at the other end to an electric appliance (10) and which connects or disconnects a power supplied from the system power line (A) to the electric appliance (100), a sensor (11) to detect environmental information, and a signal transmitter (12) to generate a predetermined signal on the basis of the environmental information detected by the sensor (11) and send the generated predetermined signal to the connector (10). For example, the sensor (11) having detected an earthquake will send an quake signal to the signal transmitter (12), and the latter will open the circuit of the connector (10) to prevent a fire possibly caused by the earthquake.

### TECHNICAL FIELD

The present invention relates to a power-off system and method for prevention of an electrically caused fire at occurrence of a disaster, and a sensor unit and power-off apparatus used in the power-off system and method.

This application claims the priority of the Japanese Patent Application No. 2005-366609 filed in the Japanese Patent Office on Dec. 20, 2005, the entirety of which is incorporated by reference herein.

### BACKGROUND ART

Occurrence of an earthquake will possibly lead to a fire of a residential house. Prevention of such fire (secondary disaster) is essential against expansion of the disaster. On this account, there has been proposed a technique for interrupting a power supply by tripping a circuit breaker lever depending upon the magnitude of an earthquake (as in the Japanese Patent Laid Open No. 21814 of 1998 which will be referred to as “Patent Document 1” hereunder).

As described in the above Patent Document 1, however, in case the power-off apparatuses are connected to arbitrary power outlets independently of each other, if an earthquake occurs, it is possible as the case may be that some of the power-off apparatuses are put into operation while the other are not.

Also, in case a power-off apparatus is connected to an incoming line or distribution board in a residential house to turn off all the power outlets in the residential house, when an earthquake occurs, the power-off apparatus will disconnect all the power outlets from the incoming line or distribution board by the power-off apparatus. In this case, the electric lights in the corridors will also be turned off, for example. In total darkness, the people living in the house will not possibly find their way to outside the house or to a safe place.

Also, according to the administrative official's recommendation, the house dwellers or power consumers themselves should take a safety measure at occurrence of a disaster or when leaving their house (by opening the circuit breaker or disconnecting the plug of each electric apparatus from the outlet, for example). Actually, however, if a disaster takes place, various things will fall down in the house rooms to blind the plugs and outlets and many of the house dwellers will be in a panic. Namely, the people will possibly be unable to calmly take any action for protection against electrical hazard at occurrence of an earthquake.

Details of the above are referred to the “Report on the Session of Investigation of Electrical Installation Disaster—Prevention Measures—For Electrical Installations Strong against Earthquake (Theory of Operation)” (on Nov. 24, 1995 hosted by the Investigation Commission for Electrical Installation Disaster-Prevention Measures; edited by the Agency of Natural Resources and Energy and published by the Electric Power Courier) and “Guideline for Dwelling-House Distribution Boards with Seismic Sensor” (established on Nov. 9, 2001; published by the Japan Wiring Accessory Makers Association).

### DISCLOSURE OF THE INVENTION

It is therefore desirable to provide a power-off system and method, capable of controlling a power supply system installed for an entire residential house at occurrence of an earthquake to automatically disconnect, from the power supply system, only an arbitrary one or ones of power outlets connected to the power supply system, for example, only one or ones of the power outlets which will possibly cause a second disaster.

It is also desirable to provide a power-off system installable inexpensively and easily in an existing residential house as well and a power-off method to be adopted in the power-off system.

It is also desirable to provide a sensor unit and power-off apparatus to be adopted in the above power-off system and method.

According to the present invention, there is provided a power-off system including:

a connector connected at one end thereof to a power supply system and at the other end to an electric appliance and which connects or disconnects the power supplied from the power supply system to the electric appliance;

a sensor to detect environmental information; and

a signal transmitter to generate a predetermined signal on the basis of the environmental information detected by the sensor and send the generated predetermined signal to the connector.

In the above power-off system, the connector includes a receiver to receive the predetermined signal sent from the signal transmitter, and makes switching on the basis of the predetermined signal received by the receiver to shut off the power supply from the power supply system to the electric appliance.

According to the present invention, there is also provided a power-off method wherein

environmental information is detected by a sensor, an environmental information signal is generated based on the detected environmental information and the generated environmental signal is sent,

a predetermined signal is generated by a signal transmitter on the basis of the environmental information signal sent from the sensor and the generated predetermined signal is sent,

a connector, connected at one end thereof to a power supply system and at the other end to an electric appliance and which connects or disconnects the power supplied from the power supply system to the electric appliance, makes switching on the basis of the predetermined signal sent from the signal transmitter to shut off the power supply from the power supply system to an electric appliance.

According to the present invention, there is also provided a power-off system according to the present invention may be formed from an integration of the sensor and signal transmitter. More specifically, the power-off system includes a connector connected at one end thereof to a power supply system and at the other end to an electric appliance and which makes switching to connect or disconnect the power supplied from the power supply system to the electric appliance, and a sensor unit. The sensor unit includes a sensor to detect environmental information, signal generator to generate a predetermined signal on the basis of the environmental information detected by the sensor and a signal transmitter to send the predetermined signal generated by the signal generator to the connector. The connector has a receiver to receive the predetermined signal sent from the signal transmitter of the sensor unit, and makes switching on the basis of the predetermined signal received by the receiver to shut off the power supply from the power supply system to the electric appliance.

According to the present invention, there is also provided a power-off method wherein

environmental information is detected by an incorporated sensor, an environmental information signal is generated based on the detected environmental information and the generated predetermined signal is sent from a sensor unit to a connector connected at one end thereof to a power supply system and at the other end to an electric appliance and which connects or disconnects the power supplied from the power supply system to the electric appliance, and

the connector makes switching on the basis of the predetermined signal sent from the sensor unit to shut off the power supply from the power supply system to the electric appliance.

According to the present invention, there is also provided a sensor unit destined for use in a power-off system which is an integration of a sensor and signal transmitter and which controls the switching of a connector connected at one end thereof to a power supply system and at the other end to an electric appliance to connect or disconnect the power supplied from the power supply system to the electric appliance. The sensor unit includes a sensor to detect environmental information, signal generator to generate a predetermined signal on the basis of the environmental information detected by the sensor and a signal transmitter to send the predetermined signal generated by the signal generator to the connector. The sensor unit controls the connector to make switching on the basis of the predetermined signal to shut off the power supply from the power supply system to the electric appliance.

According to the present invention, there is also provided a power-off apparatus destined for common use in two power-off systems and which includes a terminal connected to a power supply system and having an electric appliance connected thereto to supply a power to the electric appliance, receiver to receive a predetermined signal based on environmental information detected by a sensor, and a switch to shut off the power supply from the power supply system to the electric appliance on the basis of the predetermined signal received by the receiver.

According to the present invention, there can be built inexpensively and easily a power-off system which forcibly shuts off only a power supplied to an arbitrary electric appliance such as an electric heater upon occurrence of an earthquake. Therefore, even when the earthquake has caused power interruption and then power supply has been recovered, the arbitrary electric appliance can be kept turned off, to thereby prevent any second disaster. On the other hand, electric appliances other than such an electric heater can be supplied again with a power, for example, the corridor lights necessary for evacuation can be turned off.

### BRIEF DESCRIPTION OF THE DRAWINGS

FIG. 1 is a block diagram of a power-off system according to the present invention.

FIG. 2 is a block diagram of a connected included in the power-off system according to the present invention.

FIG. 3 is a block diagram of a sensor included in the power-off system according to the present invention.

FIG. 4 is a block diagram of a signal transmitter included in the power-off system according to the present invention.

FIG. 5 explains in detail an application of the power-off system according to the present invention.

FIG. 6 shows a flow of operations made in the power-off system according to the present invention.

FIG. 7 is a block diagram of a sensor unit which is an integration of a sensor and connector.

### BEST MODE FOR CARRYING OUT THE INVENTION

The power-off system according to the present invention uses a wireless sensor network (WSN) complying with a predetermined wireless sensor standard (e.g., ZigBee (registered trademark)), for example. With various types of sensors complying with a wireless sensor standard and featured by a small size, reduced weight, inexpensiveness and power-saving, automatic buildup of a network, etc., the power-off system controls the power supply from each power outlet in an entire residential house at occurrence of an earthquake or the like.

Especially, using various small, power-saving and wireless sensors, the power-off system according to the present invention can be installed very easily without the necessity of wiring and initialization.

<Overall Configuration>

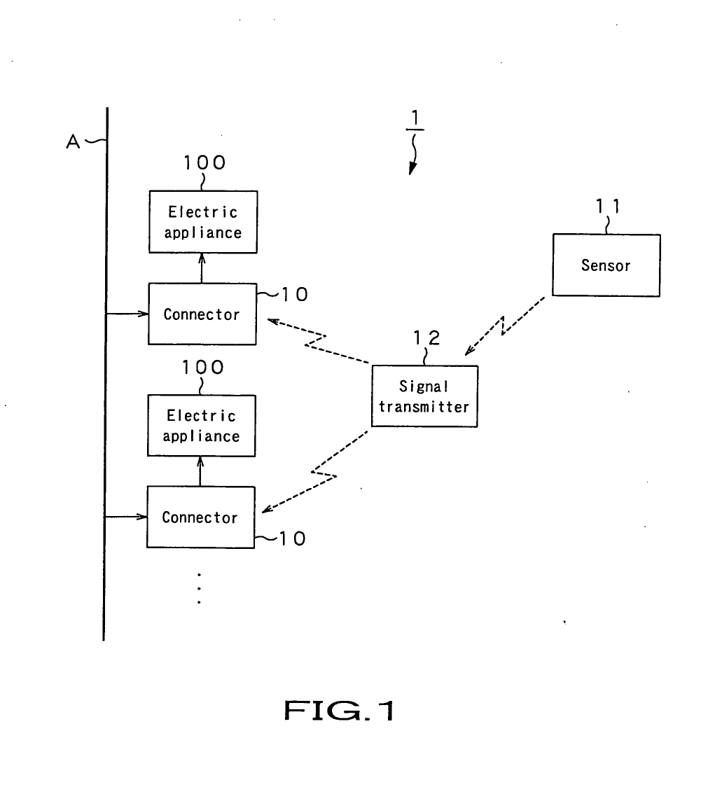

As shown in FIG. 1, the power-off system as an embodiment of the present invention, generally indicated with a reference numeral 1, includes a connector 10 connected at one end thereof to a system power line A and at the other end to an electric appliance 100 and which connects or disconnects a power supplied from the system power line A to the electric appliance 100, a sensor 11 to detect environmental information, and a signal transmitter 12 to generate a predetermined signal on the basis of the environmental information detected by the sensor 11 and send the generated predetermined signal to the connector 10.

Note that the electric appliance 100 is, for example, an electric heater, bath heater which heats water in a water bath or the like. Namely, it has a function to convert electricity into heat or a similar function. Also, it is a desk lamp using an incandescent lamp or the like.

The connector 10 receives the predetermined signal sent from the signal transmitter 12 and shuts off a power supply from the system power line A to the electric appliance 100.

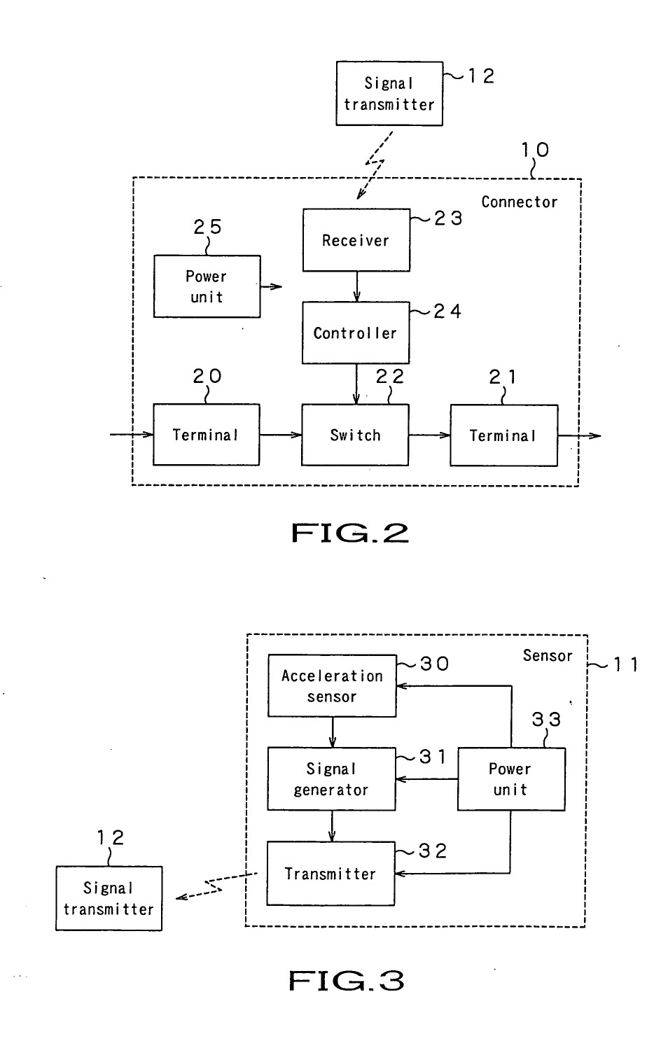

The connector 10 is constructed as will be described below. As shown in FIG. 2, the connector 10 includes, for example, a plug-shaped terminal 20 to be plugged into a receptacle type outlet provided on a wall of a residential house and electrically connected to the system power line A, receptacle-type terminal 21 to supply a power to the electric appliance 100, switch 22 to make electrical connection or disconnection between the terminals 20 and 21, receiver 23 to receive a signal S2 supplied from the signal transmitter 12, and a controller 24 to turn off the switch 22 on the basis of the signal S2 received by the receiver 23. The connector 10 further includes a power unit 25 that supplies a power to the receiver 23, controller 24, etc.

The connector 10 is designed for plugging into the outlet, and can thus be connected to a user-desired outlet. Also, with it being taken in consideration that the connector 10 is installed in a dusty environment for a long term in many cases, the terminal 20 to be plugged into the outlet is designed for its electrical connection not to easily be exposed to outside and disengaged from the outlet.

Note that the switch 22 is kept turned on normally (while no signal S2 is supplied from the signal transmitter 12). Therefore, being supplied with a power from the system power line A, the electric appliance 100 is ready for operation.

Although the connector 10 is to be plugged in an outlet as above, it may also be of such a fixed type as is to be fixed to the back of a wall or the like. In case the connector 10 is of a fixed type, it will not be exposed at the wall front, which will save the room space. The connector 10 may also incorporate a leak detector that is to turn off the switch 22 for shutting off a power when a leak is detected. In case the leak detector is included in the connector 10, the latter will function as a ground-fault circuit interrupter for each outlet.

Also, the power unit 25 is to be plugged in the receptacle type outlet installed on the room wall or the like for supplying a power from the electrically connected plug type terminal 20 to the receiver 23, controller 24, etc.

Note that the power unit 25 may be a small battery or the like independent of the system power line A for the connector 10 to be able to operate independently of the power supply from the system power line A.

As shown in FIG. 3, the sensor 11 includes an acceleration sensor 30 to detect an earthquake-caused swing, signal generator 31 to generate a predetermined signal S1 correspondingly to the magnitude of a detected swing, transmitter 32 to send the generated signal S1 to the signal transmitter 12, and a power unit 33 to supply a power to each of the components. The sensor 11 is installed to a stationary portion such as the wall of a residential house to which a vibration caused in daily life will not easily be transmitted, for example. The acceleration sensor 30 uses, for example, a gyroscope or piezoelectric element to detect a quake. For example, the sensor 30 is set in sensitivity to a predetermined intensity of 5 of an earthquake wave (170 to 250 gals). When the earthquake exceeds the predetermined intensity, the sensor 30 outputs a detection signal.

The signal generator 31 generates a predetermined signal S1 as a detection signal when a vibration detected by the acceleration sensor 30 exceeds the predetermined level, and the predetermined signal S1 as an environmental information signal is sent from the transmitter 32 to the signal transmitter 12.

Note that the sensor 11 may include a setting unit to set a predetermined quake the acceleration sensor 30 will react with (earthquake intensity), that is, a predetermined intensity. With a degree of a quake being set, it is possible to determine an earthquake intensity at which, for example, the switch 22 is turned off. For example, the sensor 11 may be set not to detect a quake such as a low-intensity earthquake, vibration caused in daily life, etc.

According to the present invention, a thermosensor/smoke sensor to detect a temperature and smoke may also be used along with the acceleration sensor 30 to detect a fire or the like. In this case, when a value detected by the thermosensor/smoke sensor is higher than predetermined, the signal generator 31 generates a predetermined signal S1 as a detection signal and sends the generated predetermined signal S1 from the transmitter 32 to the signal transmitter 12. It should be noted that the thermosensor/smoke sensor detects a temperature and smoke by detecting infrared rays and gas, respectively.

Therefore, in case the sensor 11 including both the acceleration sensor 30 and thermosensor/smoke sensor, the power supply to each outlet in an entire residential house can be controlled correspondingly to an earthquake or fire. It should be noted that the sensor 11 will be described below concerning only the acceleration sensor 30 for the simplicity of explanation.

Also, the sensor 11 has not to be connected to any AC source because it uses a small battery as the power unit 33 and the battery will work for more than one year so long as the sensor is used with a normal frequency. Therefore, the entire system can be installed easily with less labor and less power consumption. Also, the sensor 11 can continuously operate irrespectively of the power supply from the system power line A.

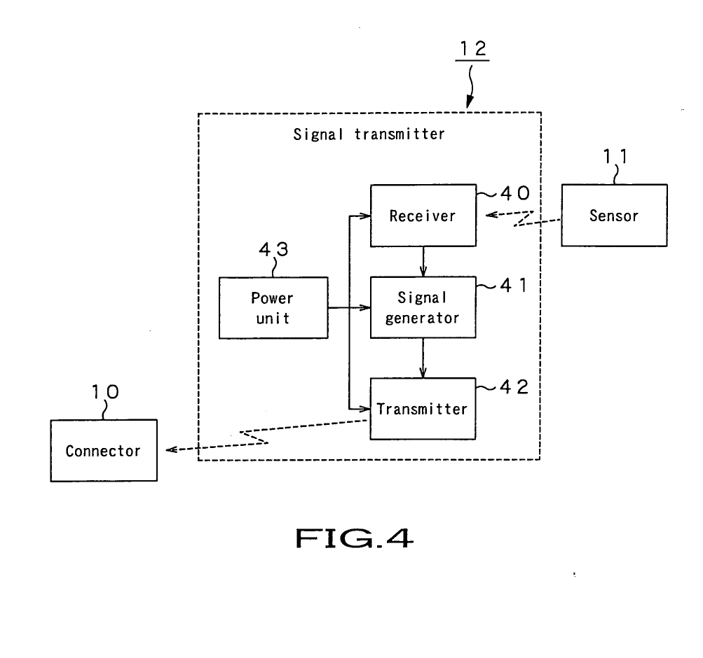

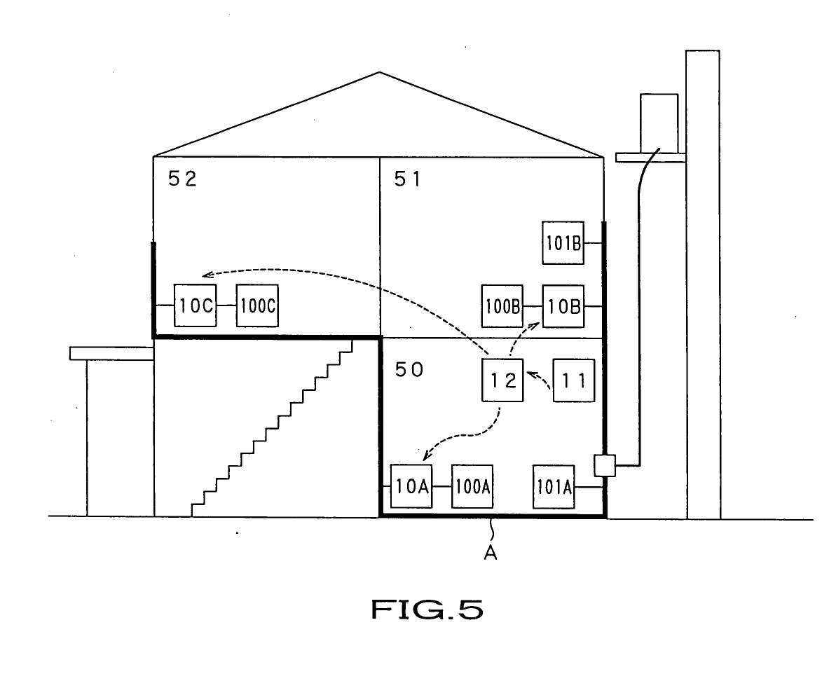

The signal transmitter 12 is a so-called sensor server. As shown in FIG. 4, it includes a receiver 40 to receive a signal S1 sent from the sensor 11, signal generator 41 to generate a signal S2 in response to the signal S1 received by the receiver 40, and a transmitter 42 to send the generated signal S2 to the connector 10. The signal transmitter 12 further includes a power unit 43 that supplies a power to the receiver 40, signal generator 41 and transmitter 42. The power unit 43 is connected to the system power line A via an outlet or the like. The signal transmitter 12 may also adapted to operate independently of power supply from the system power line A with the use of a small battery or the like independent of the system power line A.

The sensor 11 and signal transmitter 12 may be provided integrally with each other, which will be described in detail later.

Also, in the power-off system 1, the receiver 23 included in the sensor 10, transmitter 32 included in the sensor 11 and receiver 40 and transmitter 42 included in the signal transmitter 12 are designed in compliance with the IEEE 802.15.4 (ZigBee (registered trademark)) and can thus receive and send signals among them even if there is a shielding such as an indoor wall, partition or the like between these system components. It should be noted that the communication system may be a small-power radio system in which a radio wave can reach over a distance of at least 10 meters or a wired communication system.

<Application of the Present Invention>

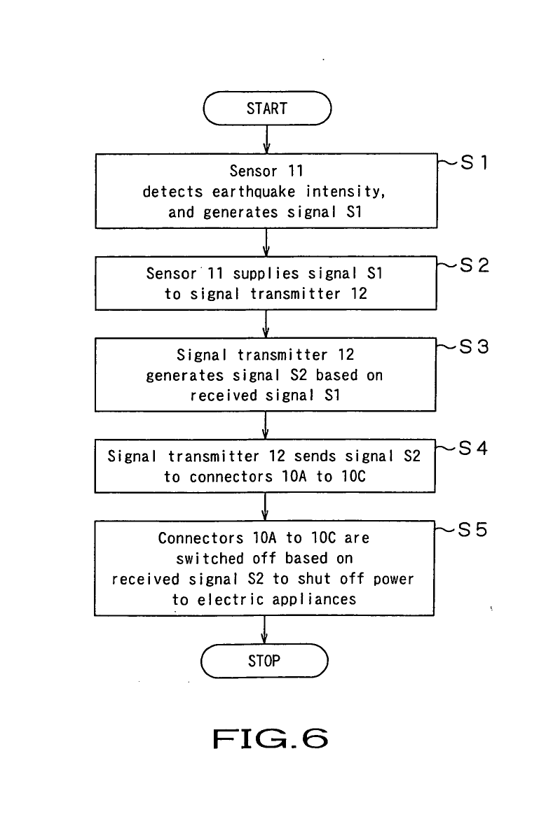

Next, there will be described an example application of the power-off system 1 according to the present invention. FIG. 5 is a schematic sectional view of a residential house (including rooms 50 to 52). As shown in FIG. 5, a power is led from outside the residential house into the latter via the system power line A. Namely, the power is supplied to each of the rooms 50 to 52 via the system power line A. Also, in the room 50, an electric appliance 100A is provided being connected to the system power line A via a connector 10A, an electric appliance 101A is provided being connected directly to the system power line A, and there are also disposed the sensor 11 and signal transmitter 12.

Also, in the room 51, an electric appliance 100B is connected to the system power line A via a connector 10B, and an electric appliance 101B is connected directly to the system power line A.

Also, in the room 52, an electric appliance 100C is connected to the system power line A via a connector 10C.

Note that the electric appliances 101A and 101B connected directly to the system power line A are a telephone set or the like. Different from the electric appliance 100, they are, for example, a device which has not the function to make electricity-heat conversion and will not thus cause any fire or the like even if it falls down at occurrence of a disaster. Also, electric appliances connected to the connectors 10A, 10B and 10C are, for example, an electric heater, bath heater to warm water in a water bath and a desk lamp using an incandescent lamp as a light source.

The power-off system 1 according to the present invention operates when an earthquake has an impact on the residential house, as will be described below with reference to the flow diagram in FIG. 6.

At occurrence of an earthquake, the sensor 11 detects the intensity of the earthquake, and generates a signal S1 (in step S1). Then, the sensor 11 supplies the generated signal S1 to the signal transmitter 12 (in step S2).

The signal transmitter 12 generates a signal S2 on the basis of the received signal S1 (in step S3), and sends the signal S2 to the connectors 10A, 10B and 10C (in step S4).

The connector 10A turns off the switch on the basis of the received signal S2 to break the electrical connection, the connector 10B turns off the switch on the basis of the received signal S2 to break the electrical connection, and the connector 10C turns off the switch on the basis of the received signal S2 to break the electrical connection (in step S5).

Therefore, the electric appliances 100A, 100B and 100C will not be supplied with the power. Namely, the power transmission will be interrupted due to the earthquake. Even when the power transmission is recovered thereafter, the electric appliances 100A, 100B and 100C will not be put into operation. These electric appliances 100 have a heat source, but since they are not put into operation again even when the power supply is resumed after the earthquake, a second disaster such as a fire will be prevented from taking place.

On the other hand, the electric appliances 101A and 101B are connected directly to the system power line A. So, when the power transmission is recovered, they will be supplied with the power again. That is, the electric appliances 101A and 101B are not controlled by the respective connectors 10. When the power supply from the system power line A is resumed after the disaster, the power is supplied to these electric appliances which will thus be put into operation again. Therefore, the communication or the like by the telephone can be resumed.

Also, the connectors 10A, 10B and 10C, whose switches are turned off, may be designed to be turned on together by the user or individually with a manual operation by the user.

As above, the power-off system 1 according to the present invention includes the connectors 10 connected at one end thereof to the system power line A and at the other end to the electric appliances 100, respectively, to connect or disconnect the power supplied from the system power line A to the electric appliances 100, sensor 11 to detect environmental information (such as information on the swing due to an earthquake, information on temperature and smoke due to a fire), and signal transmitter 12 to generate a predetermined signal on the basis of the environmental information and send the generated predetermined signal to the connectors 10. With the connectors 10 being disposed between the electric plugs of the arbitrary (a plurality of) electric appliances 100 and outlets supplied with a power from the system power line A, the power supply to the arbitrary electric appliances 100 can forcibly be shut off at occurrence of an earthquake, the power transmission can be interrupted, and the power supply to the arbitrary electric appliances 100 can be kept interrupted even after the power transmission is resumed thereafter. Thus, any second disaster can be prevented from taking place.

The operation of the sensor in the residential house at occurrence of an earthquake has been explained above. When the power supply system, namely, the substation, has first been supplied with the power from the power line, the switches 22 of the connectors 10 in each residential house in a residential district will be kept closed while the power transmission is being interrupted. In this case, when the power transmission from the substation has been resumed after confirmation of the safety of the substation and the like, the controller 24 in the connector 10 will detect a change of the current and/or voltage supplied at the time of power recovery, that is, a predetermined change of the current and/or voltage (change at the time of power recovery) increased starting at a reference value which is a fall of the current and/or voltage to about zero at the time of power interruption, and will change the switch 22 from the on state to off state, to thereby prevent the electric appliance 100 from being supplied with the power. Thus, even if the electric appliance 100 in the residential house is fallen or out of order, the power supply to the electric appliance 100 can be inhibited when the power transmission is resumed, whereby a second disaster can be prevented from taking place. It should be noted that this safety operation is also applicable in case a small battery independent of the system power line A is used as the power unit 25 in the connector 10 as necessary.

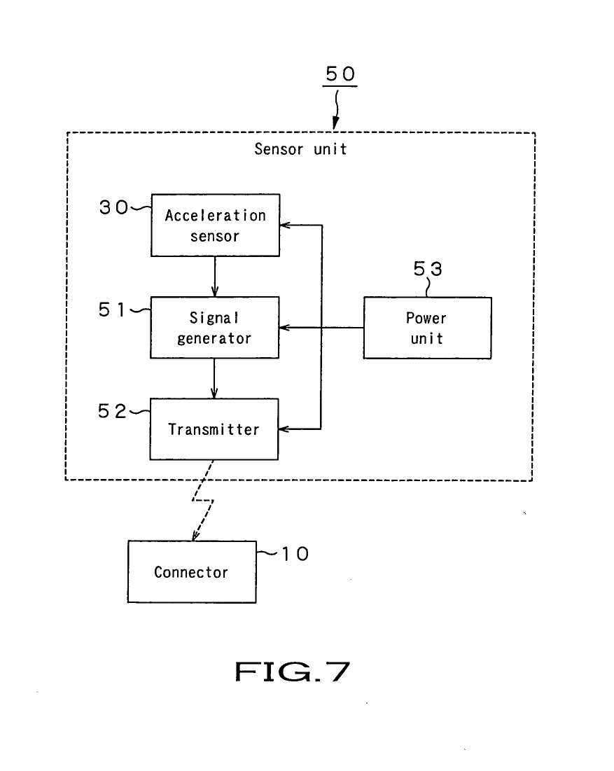

In the application described above, the sensor 11 and signal transmitter 12 are separate from each other. According to the present invention, however, they may be combined integrally with each other. As shown in FIG. 7, a sensor unit 50 formed from an integral combination of the sensor 11 and signal transmitter 12 includes an acceleration sensor 30, signal generator 51 to generate a predetermined signal on the basis of a value detected by the acceleration sensor 30, transmitter 52 to send the signal generated by the signal generator 51 to the connector 10, and a power unit 53 to supply a power to the acceleration sensor 30, signal generator 51, transmitter 52, etc.

The power unit 53 may be a small battery as mentioned above. However, it is connected to an outlet and thus supplied with an AC power from the system power line A. Since the connector 10 is disposed for a long term in a place where it is exposed to dust or the like, the terminal of the power unit, which is to be plugged in the outlet, should be designed so that a portion thereof electrically connected to the outlet will not easily be exposed to outside and disengaged from the outlet. Also, the sensor may be designed to function as the acceleration sensor 30 or as a combination of the acceleration sensor 30 and a thermosensor/smoke sensor.

The above sensor unit 50 should preferably be installed on the wall of a residential house, stationary portion of a wattmeter, molded-case circuit-breaker or the like to which a vibration caused in daily life will not easily be transmitted, for example. More preferably, the sensor unit 50 should be installed on the outlet for an air conditioner or on the power distribution board, located near the room ceiling or at a height where anything will not accidentally collide with the sensor unit 50 in daily life. The sensor unit 50 operates similarly to the aforementioned sensor 11 and signal transmitter 12.

Note that the sensor unit 50 may also include a transmitter which will inform the owner or the like of the residential house by electronic mail, for example, of a vibration detected by the acceleration sensor 30 and having a larger value than predetermined,. In this case, the sensor unit 50 includes an electronic mail generator to generate, when the acceleration sensor 30 has detected a vibration whose value is larger than predetermined, an electronic mail alarming the large-scale earthquake, and send the electronic mail generated by the electronic mail generator according to a communication protocol such as the TCP/IP or the like. The sensor unit 50 may be supplied with a power from the terminal 21 of the connector 10. In case the electronic mail sending function is provided, however, an electronic mail has to be sent after the connector 10 shuts off the power supply. In this case, the sensor unit 50 should be supplied with a power from other than the terminal 21 of the connector 10.

Further, in case the sensor unit 50 is connected to a distribution board, a current sensor may be connected to the electric circuit and a display panel having a plurality of LEDs and an LCD be provided on the connector 10, to thereby measure a power used in the whole residential house, send the measurement to the connector 10 via radio waves and indicate the power consumption on the display panel. Thus, the people living in the house can be informed of the power consumption, which will lead to power saving.

In the foregoing, the present invention has been described in detail concerning certain preferred embodiments thereof as examples with reference to the accompanying drawings. However, it should be understood by those ordinarily skilled in the art that the present invention is not limited to the embodiments but can be modified in various manners, constructed alternatively or embodied in various other forms without departing from the scope and spirit thereof as set forth and defined in the appended claims.

1. A power-off system, comprising:
a connector connected at one end thereof to a power supply system and at the other end to an electric appliance and which connects or disconnects the power supplied from the power supply system to the electric appliance;
a sensor to detect environmental information; and
a signal transmitter to generate a predetermined signal on the basis of the environmental information detected by the sensor and send the generated predetermined signal to the connector,
the connector including a receiver to receive the predetermined signal sent from the signal transmitter and making switching on the basis of the predetermined signal received by the receiver to shut off the power supply from the power supply system to the electric appliance.

2. The power-off system according to claim 1, wherein the sensor is a vibration sensor fixed in an arbitrary place on a building structure to detect a vibration of the latter, and includes a transmitter to generate a detection signal when a detected vibration of the building structure exceeds a predetermined value and send the generated detection signal to the signal transmitter.

3. The power-off system according to claim 1 or 2, wherein the sensor is a thermosensor/smoke sensor fixed in an arbitrary place on the building structure to detect a temperature and/or smoke, and includes a transmitter to generate a detection signal when a detected temperature and/or smoke in the building structure exceeds a predetermined value and send the generated detection signal to the signal transmitter.

4. The power-off system according to claim 1, wherein the connector and/or sensor has a battery as a power unit.

5. The power-off system according to claim 1, wherein the connector and/or sensor has a power unit connected to the power supply system.

6. The power-off system according to claim 1, wherein the electric appliance connected to the connector has an electricity-heat conversion function.

7. The power-off system according to claim 1, wherein the connector makes switching to shut off the power supply to the electric appliance when a predetermined change of a current and/or voltage, increased starting at a reference value, is detected at the time of power recovery.

8. A power-off method, wherein
environmental information is detected by a sensor, an environmental information signal is generated based on the detected environmental information and the generated environmental signal is sent,
a predetermined signal is generated by a signal transmitter on the basis of the environmental information signal sent from the sensor and the generated predetermined signal is sent, and
a power supply from a power supply system to an electric appliance is shut off through switching, made based on the predetermined signal sent from the signal transmitter, by a connector connected at one end thereof to the power supply system and at the other end to the electric appliance and which connects or disconnects the power supplied from the power supply system to the electric appliance.

9. A power-off system, comprising:
a connector connected at one end thereof to a power supply system and at the other end to an electric appliance and which connects or disconnects the power supplied from the power supply system to the electric appliance; and
a sensor unit including a sensor to detect environmental information, signal generator to generate a predetermined signal on the basis of the environmental information detected by the sensor and a signal transmitter to send the predetermined signal generated by the signal generator to the connector,
the connector having a receiver to receive the predetermined signal sent from the signal transmitter of the sensor unit, and making switching on the basis of the predetermined signal received by the receiver to shut off the power supply from the power supply system to the electric appliance.

10. The power-off system according to claim 9, wherein
the sensor unit is fixed in an arbitrary place on a building structure,
the sensor is a vibration sensor to detect a variation of the latter, and
the sensor unit includes a transmitter which generates a detection signal when a vibration of the building structure, detected by the sensor, exceeds a predetermined value, and sends the generated detection signal to the signal transmitter.

11. The power-off system according to claim 9 or 10, wherein
the sensor unit is fixed in an arbitrary place of the building structure,
the sensor is a thermosensor/smoke sensor to detect a temperature and/or smoke, and
the sensor unit includes a transmitter which generates a detection signal when a detected temperature and/or smoke in the building structure exceeds a predetermined value, and sends the generated detection signal to the signal transmitter.

12. The power-off system according to claim 9, wherein the connector and/or sensor unit has a battery as a power unit.

13. The power-off system according to claim 9, wherein the connector and/or sensor unit has a power unit connected to the power supply system.

14. The power-off system according to claim 9, wherein the electric appliance connected to the connector has an electricity-heat conversion function.

15. The power-off system according to claim 9, wherein the connector makes switching, when a predetermined change of a current and/or voltage, increased starting at a reference value, is detected at the time of power recovery, to shut off the power supply to the electric appliance.

16. A power-off method, wherein
environmental information is detected by an incorporated sensor, an environmental information signal is generated based on the detected environmental information and the generated predetermined signal is sent from a sensor unit to a connector connected at one end thereof to a power supply system and at the other end to an electric appliance and which connects or disconnects the power supplied from the power supply system to the electric appliance, and
the connector makes switching on the basis of the predetermined signal sent from the sensor unit to shut off the power supply from the power supply system to the electric appliance.

17. A sensor unit to control the switching of a connector connected at one end thereof to a power supply system and at the other end to an electric appliance and which connects or disconnects the power supplied from the power supply system to the electric appliance, the sensor unit comprising:
a sensor to detect environmental information;
a signal generator to generate a predetermined signal on the basis of the environmental information detected by the sensor; and
a signal transmitter to send the predetermined signal generated by the signal generator to the connector,
the sensor unit controlling the connector on the basis of the predetermined signal sent from the signal transmitter to shut off the power supply from the power supply system to the electric appliance.

18. A power-off apparatus comprising:
a terminal connected to a power supply system and having an electric appliance connected thereto to supply a power to the electric appliance;
a receiver to receive a predetermined signal based on environmental information detected by a sensor; and
a switch to shut off the power supply from the power supply system to the electric appliance on the basis of the predetermined signal received by the receiver.

19. The power-off apparatus according to claim 18, further comprising a terminal which is plugged in an outlet provided on a stationary portion and connected to the power supply system.

20. The power-off apparatus according to claim 18, further comprising a controller which controls the switching of the connector, when a predetermined change of a current and/or voltage, increased starting at a reference value, is detected at the time of power recovery, to shut off the power supply to the electric appliance.
